(19) United States
(12) Patent Application Publication
(10) Pub. No.: US 2015/0220142 A1
(43) Pub. Date: Aug. 6, 2015

(54) Head-Tracking Based Technique for Moving On-Screen Objects on Head Mounted Displays (HMD)

(71) Applicant: Kopin Corporation, Westborough, MA (US)

(72) Inventors: Christopher Parkinson, Richland, WA (US); Jeffrey J. Jacobsen, Hollister, CA (US)

(21) Appl. No.: 14/610,272

(22) Filed: Jan. 30, 2015

Related U.S. Application Data
(60) Provisional application No. 61/934,683, filed on Jan. 31, 2014.

(51) Int. Cl. G06F 3/01; G06F 3/0484; G06F 3/16

(52) U.S. Cl. CPC G06F 3/012; G06F 3/167; G06F 3/04845; G06F 2203/04801

(57) ABSTRACT

A headset computer or head mounted display combines voice command and head tracking movement for cursor control and operation. Different display characteristics of the cursor are used for different modes of cursor operation. For a given mode of operation of the cursor, the user can issue a voice command for certain operations, and can move or reposition the cursor in a screen view using head tracking commands. Different modes of operation may be changed using voice commands or gestures.

### RELATED APPLICATION

This application claims the benefit of U.S. Provisional Application No. 61/934,683, filed on Jan. 31, 2014. The entire teachings of the above applications are incorporated herein by reference.

### BACKGROUND OF THE INVENTION

Mobile computing devices, such as notebook PC's, smart phones, and tablet computing devices, are now common tools used for producing, analyzing, communicating, and consuming data in both business and personal life. Consumers continue to embrace a mobile digital lifestyle as the ease of access to digital information increases with high-speed wireless communications technologies becoming ubiquitous. Popular uses of mobile computing devices include displaying large amounts of high-resolution computer graphics information and video content, often wirelessly streamed to the device. While these devices typically include a display screen, the preferred visual experience of a high-resolution, large format display cannot be easily replicated in such mobile devices because the physical size of such device is limited to promote mobility. Another drawback of the aforementioned device types is that the user interface is hands-dependent, typically requiring a user to enter data or make selections using a keyboard (physical or virtual) or touch-screen display. As a result, consumers are now seeking a hands-free high-quality, portable, color display solution to augment or replace their hands-dependent mobile devices.

### SUMMARY OF THE INVENTION

Recently developed micro-displays can provide large-format, high-resolution color pictures and streaming video in a very small form factor. One application for such displays can be integrated into a wireless headset computer worn on the head of the user with a display within the field of view of the user, similar in format to eyeglasses, audio headset or video eyewear.

A “wireless computing headset” device, also referred to herein as a headset computer (HSC) or head mounted display (HMD), includes one or more small, high resolution micro-displays and associated optics to magnify the image. The high resolution micro-displays can provide super video graphics array (SVGA) (800×600) resolution or extended graphic arrays (XGA) (1024×768) resolution, or higher resolutions known in the art.

A wireless computing headset contains one or more wireless computing and communication interfaces, enabling data and streaming video capability, and provides greater convenience and mobility through hands dependent devices.

For more information concerning such devices, see co-pending patent applications entitled “Mobile Wireless Display Software Platform for Controlling Other Systems and Devices,” U.S. application Ser. No. 12/348, 648 filed Jan. 5, 2009, “Handheld Wireless Display Devices Having High Resolution Display Suitable For Use as a Mobile Internet Device,” PCT International Application No. PCT/US09/38601 filed Mar. 27, 2009, and “Improved Headset Computer,” U.S. Application No. 61/638,419 filed Apr. 25, 2012, each of which are incorporated herein by reference in their entirety.

As used herein “HSC” headset computers, “HMD” head mounded display device, and “wireless computing headset” device may be used interchangeably.

Head-Mounted Devices (HMD) may include head-tracking capability, which allows the HMD to detect the movements of the head in any direction. The detected movements can then be used as input for various applications, such as panning a screen or screen content, or using the head-tracker to position a ‘mouse-like’ pointer.

The present invention relates to how head-tracking control can be used to gain control of, and then move, on-screen objects.

Most of the interactions relevant to head-tracking ability in a computer environment fall into one of three categories: selection, manipulation and navigation.

While head-tracking input is natural for some navigation and direct manipulation tasks, it may be inappropriate for tasks that require precise interaction or manipulation.

In one aspect, the invention is a headset computer that includes a processor configured to receive voice commands and head-tracking commands as input. The headset computer further includes a display monitor driven by the processor and a graphical user interface rendered by the processor in screen views on the display monitor. The graphical user interface employing a cursor having (i) a neutral mode of operation, (ii) a grab available mode of operation, and (iii) an object grabbed mode of operation. For the different modes of operation, the processor may display the cursor with different characteristics.

In one embodiment, the different characteristics are visual characteristics. These characteristics may include, but are not limited to color, geometric configuration, lighting/dimming, flashing and spinning

In another embodiment, the processor changes cursor mode of operation in response to voice commands by a user and changes cursor screen position/location in response to head tracking commands generated by head movements of the user. In another embodiment, the head-tracking commands include a command to activate head-tracking and a command to deactivate head-tracking In another embodiment, the head-tracking commands cause the cursor to move within the screen views. In one embodiment, for the grabbed object mode of operation, an object and the cursor may be locked together, so that the head-tracking commands cause the cursor and the object to move together within the screen views. In another embodiment, the grab available mode of operation is entered when the cursor overlaps a movable object.

In one embodiment, the neutral mode of operation, the grab available mode of operation, and the object grabbed mode of operation are entered in response to commands from the user. In one embodiment, the commands from the user are voice commands. In another embodiment, the commands from the user are gestures.

In another aspect, the invention is a method of providing hands-free movement of object on a display of a headset computer having head-tracking control, including moving, with the head-tracking control, a cursor within the display until the cursor at least partially overlaps an object within the display. The method further includes locking the cursor to the object in response to a first command. The method also includes moving, with the head-tracking control, the cursor together with the object, from a first position within the display to a second position within the display.

In one embodiment, the method further includes unlocking the cursor from the object in response to a second command.

In one embodiment, the first command and the second command are voice commands. In another embodiment, the first command and the second command are gestures.

In one embodiment, the method further includes activating the head-tracking control prior to moving the object, and deactivating the head-tracking control after moving the object.

In one embodiment, the method further includes waiting, once the cursor at least partially overlaps the object, for a visual characteristic of the cursor to change.

In another aspect, the invention is a non-transitory computer-readable medium with computer code instruction stored thereon, the computer code instructions when executed by an a processor cause an apparatus having head-tracking control to move, using head-tracking control, a cursor within the display until the cursor at least partially overlaps an object within the display. The instructions may also cause the apparatus to lock the cursor to the object in response to a first command, and to move, using the head-tracking control, the cursor together with the object, from a first position within the display to a second position within the display.

Other aspects and embodiments of the invention, not explicitly listed in this section, are also contemplated.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1A-1B are schematic illustrations of a headset computer cooperating with a host computer (e.g., Smart Phone, laptop, etc.) according to principles of the present invention.

FIG. 2 is a block diagram of flow of data and control in the embodiment of FIGS. 1A-1B.

FIG. 3 is a block diagram of ASR (automatic speech recognition) subsystem in embodiments according to the invention.

FIGS. 4A-4D are schematic views illustrating example embodiments according to the invention.

### DETAILED DESCRIPTION OF THE INVENTION

A description of example embodiments of the invention follows.

The teachings of all patents, published applications and references cited herein are incorporated by reference in their entirety.

The described embodiments provide a head-tracking control that may be used to grab and move objects within a user-interface on a HMD. Employing the described embodiments, the user can move objects on a display, for example within a Graphical User Interface (GUI), without requiring a traditional mouse for input.

This capability is useful in a range of scenarios, such as an environment where using a mouse is not convenient, appropriate, or both.

Head-tracking control may refer to head gestures (e.g., nodding, shaking, tilting, turning and other motions of the user's head) that are used as input to manipulate some aspect of a display. In some embodiments, the head-tracking control uses the head gestures as head tracking commands to move a cursor within a display of the headset computer.

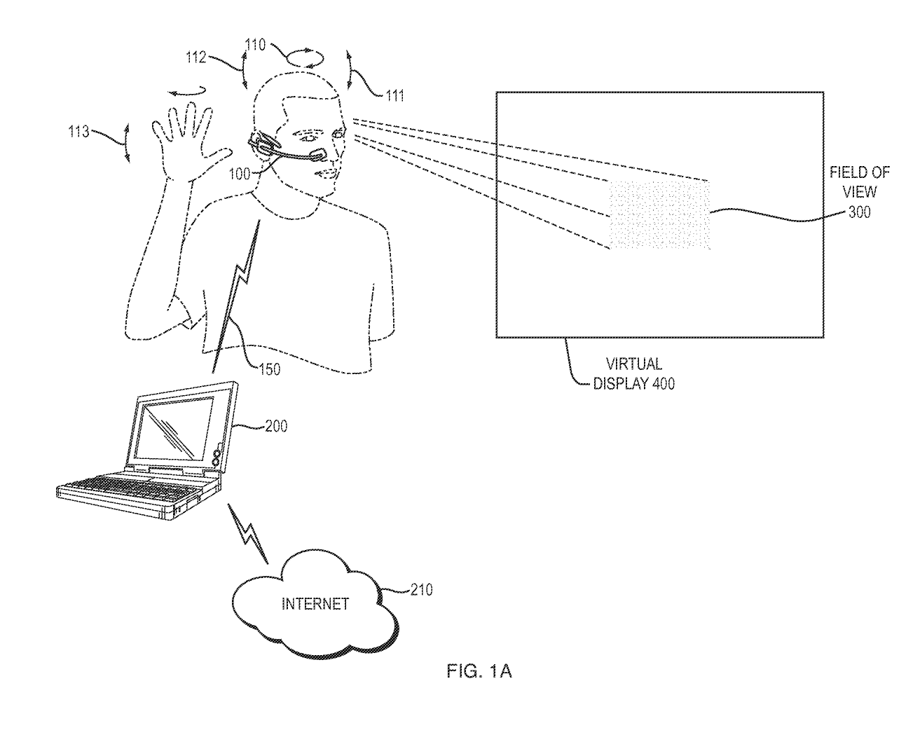

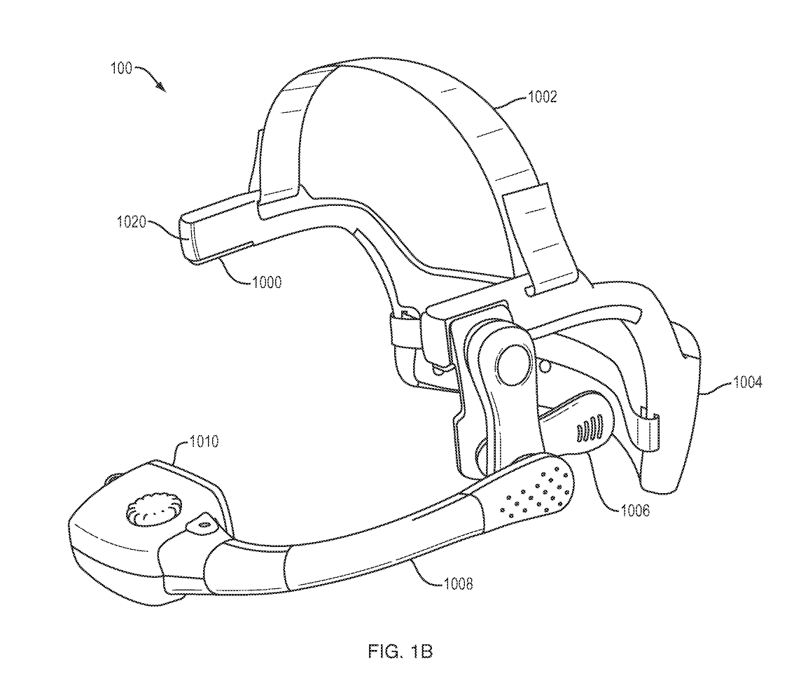

FIGS. 1A and 1B show an example embodiment of a wireless computing headset device 100 (also referred to herein as a headset computer (HSC) or head mounted display (HMD)) that incorporates a high-resolution (VGA or better) micro-display element 1010, and other features described below.

HSC 100 can include audio input and/or output devices, including one or more microphones, input and output speakers, geo-positional sensors (GPS), three to nine axis degrees of freedom orientation sensors, atmospheric sensors, health condition sensors, digital compass, pressure sensors, environmental sensors, energy sensors, acceleration sensors, position, attitude, motion, velocity and/or optical sensors, cameras (visible light, infrared, etc.), multiple wireless radios, auxiliary lighting, rangefinders, or the like and/or an array of sensors embedded and/or integrated into the headset and/or attached to the device via one or more peripheral ports 1020 (FIG. 1B).

Typically located within the housing of headset computing device 100 are various electronic circuits including, a microcomputer (single or multicore processors), one or more wired and/or wireless communications interfaces, memory or storage devices, various sensors and a peripheral mount or mount, such as a “hot shoe.”

Example embodiments of the HSC 100 can receive user input through sensing voice commands, head movements, 110, 111, 112 and hand gestures 113, or any combination thereof. A microphone (or microphones) operatively coupled to or integrated into the HSC 100 can be used to capture speech commands, which are then digitized and processed using automatic speech recognition techniques. Gyroscopes, accelerometers, and other micro-electromechanical system sensors can be integrated into the HSC 100 and used to track the user's head movements 110, 111, 112 to provide user input commands. Cameras or motion tracking sensors can be used to monitor a user's hand gestures 113 for user input commands. Such a user interface may overcome the disadvantages of hands-dependent formats inherent in other mobile devices.

The HSC 100 can be used in various ways. It can be used as a peripheral display for displaying video signals received and processed by a remote host computing device 200 (shown in FIG. 1A). The host 200 may be, for example, a notebook PC, smart phone, tablet device, or other computing device having less or greater computational complexity than the wireless computing headset device 100, such as cloud-based network resources. The headset computing device 100 and host 200 can wirelessly communicate via one or more wireless protocols, such as Bluetooth®, Wi-Fi, WiMAX, 4G LTE or other wireless radio link 150. (Bluetooth is a registered trademark of Bluetooth Sig, Inc. of 5209 Lake Washington Boulevard, Kirkland, Wash. 98033).

In an example embodiment, the host 200 may be further connected to other networks, such as through a wireless connection to the Internet or other cloud-based network resources, so that the host 200 can act as a wireless relay between the HSC 100 and the network 210. Alternatively, some embodiments of the HSC 100 can establish a wireless connection to the Internet (or other cloud-based network resources) directly, without the use of a host wireless relay. In such embodiments, components of the HSC 100 and the host 200 may be combined into a single device.

FIG. 1B is a perspective view showing some details of an example embodiment of a headset computer 100. The example embodiment HSC 100 generally includes, a frame 1000, strap 1002, rear housing 1004, speaker 1006, cantilever, or alternatively referred to as an arm or boom 1008 with a built in microphone, and a micro-display subassembly 1010.

A head worn frame 1000 and strap 1002 are generally configured so that a user can wear the headset computer device 100 on the user's head. A housing 1004 is generally a low profile unit which houses the electronics, such as the microprocessor, memory or other storage device, along with other associated circuitry. Speakers 1006 provide audio output to the user so that the user can hear information. Micro-display subassembly 1010 is used to render visual information to the user. It is coupled to the arm 1008. The arm 1008 generally provides physical support such that the micro-display subassembly is able to be positioned within the user's field of view 300 (FIG. 1A), preferably in front of the eye of the user or within its peripheral vision preferably slightly below or above the eye. Arm 1008 also provides the electrical or optical connections between the micro-display subassembly 1010 and the control circuitry housed within housing unit 1004.

According to aspects that will be explained in more detail below, the HSC display device 100 allows a user to select a field of view 300 within a much larger area defined by a virtual display 400. The user can typically control the position, extent (e.g., X-Y or 3D range), and/or magnification of the field of view 300.

While what is shown in FIGS. 1A and 1B is a monocular micro-display presenting a single fixed display element supported on the face of the user with a cantilevered boom, it should be understood that other mechanical configurations for the remote control display device 100 are possible, such as a binocular display with two separate micro-displays (e.g., one for each eye) or a single micro-display arranged to be viewable by both eyes.

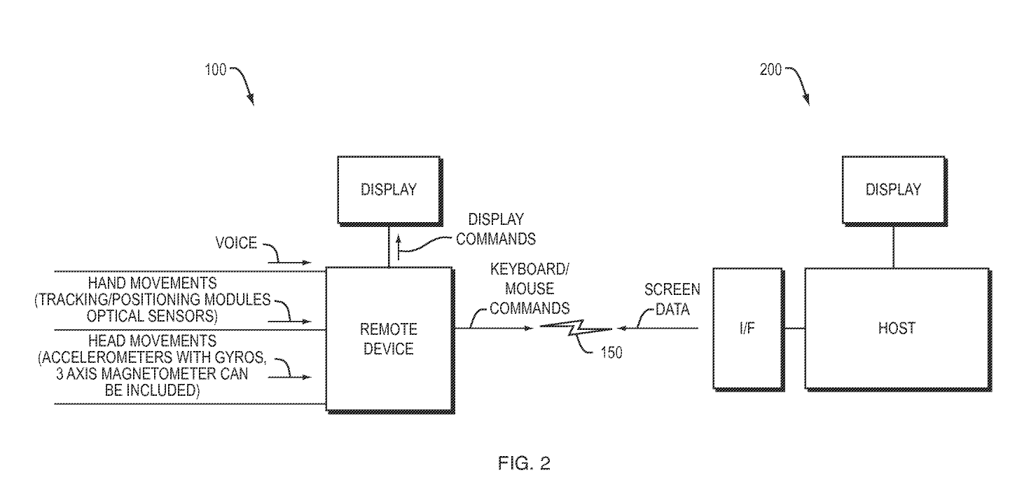

FIG. 2 is a block diagram showing more detail of an embodiment of the HSC or HMD device 100, host 200 and the data that travels between them. The HSC or HMD device 100 receives vocal input from the user via the microphone, hand movements or body gestures via positional and orientation sensors, the camera or optical sensor(s), and head movement inputs via the head tracking circuitry such as 3 axis to 9 axis degrees of freedom orientational sensing. These are translated by software (processors) in the HSC or HMD device 100 into keyboard and/or mouse commands that are then sent over the Bluetooth or other wireless interface 150 to the host 200. The host 200 then interprets these translated commands in accordance with its own operating system/application software to perform various functions. Among the commands is one to select a field of view 300 within the virtual display 400 and return that selected screen data to the HSC or HMD device 100. Thus, it should be understood that a very large format virtual display area might be associated with application software or an operating system running on the host 200. However, only a portion of that large virtual display area 400 within the field of view 300 is returned to and actually displayed by the micro display 1010 of HSC or HMD device 100.

In one embodiment, the HSC 100 may take the form of the device described in a co-pending US Patent Publication Number 2011/0187640, which is hereby incorporated by reference in its entirety.

In another embodiment, the invention relates to the concept of using a Head Mounted Display (HMD) 1010 in conjunction with an external ‘smart’ device 200 (such as a smartphone or tablet) to provide information and control to the user hands-free. The invention requires transmission of small amounts of data, providing a more reliable data transfer method running in real-time.

In this sense therefore, the amount of data to be transmitted over the connection 150 is relatively small, because the data transmitted is simply instructions on how to lay out a screen, which text to display, and other stylistic information such as drawing arrows, or the background colors, images to include, for example.

Additional data could be streamed over the same 150 or another connection and displayed on screen 1010, such as a video stream if required by the host 200.

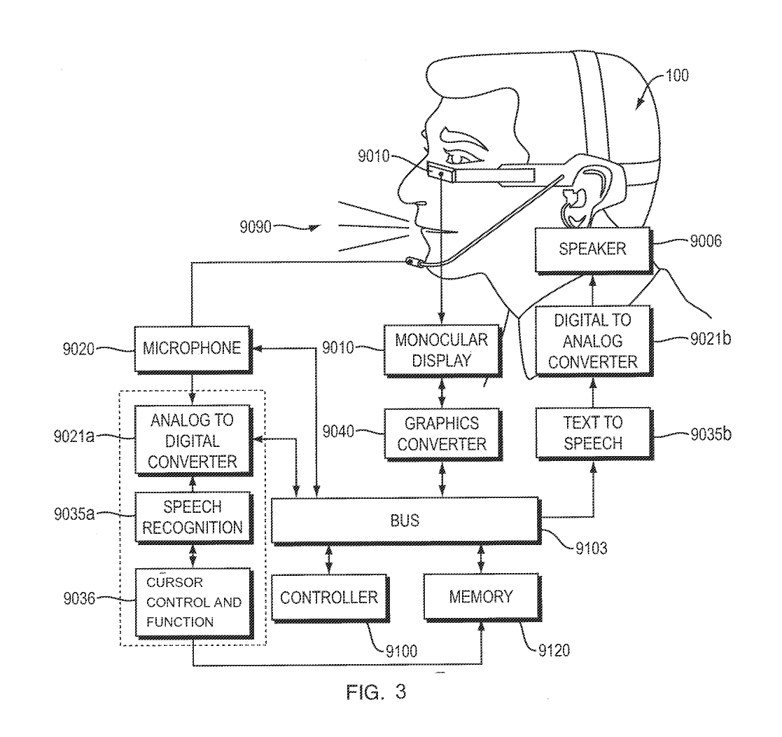

FIG. 3 shows an example embodiment of a wireless hands-free video computing headset 100 under voice command, according to one embodiment of the present invention. The user may be presented with an image on the micro-display 9010, for example, as output by host computer 200 application mentioned above. A user of the HMD 100 can employ joint head-tracking and voice command text selection software module 9036, either locally or from a remote host 200, in which the user is presented with a sequence of screen views implementing hands free text selection on the micro-display 9010 and the audio of the same through the speaker 9006 of the headset computer 100. Because the headset computer 100 is also equipped with a microphone 9020, the user can utter voice commands (e.g., to make command selections) as illustrated next with respect to embodiments of the present invention.

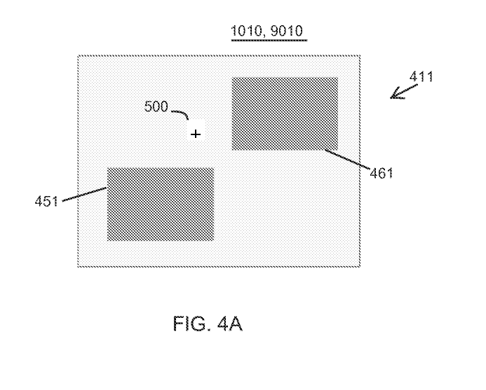

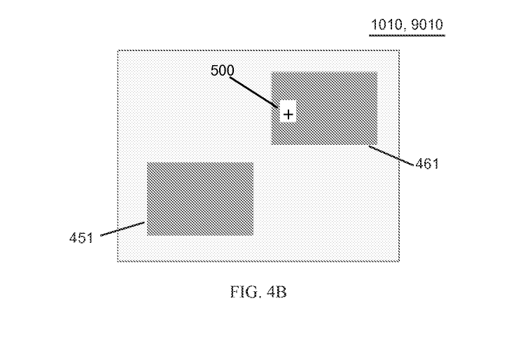

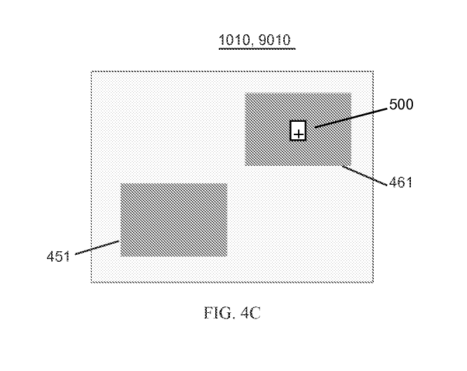

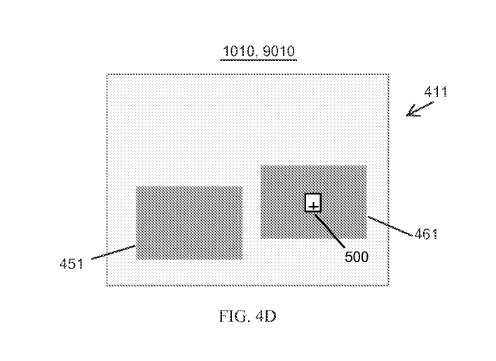

FIG. 3 shows a schematic diagram illustrating the modules of the headset computer 100. FIG. 3 includes a schematic diagram of the operative modules of the headset computer 100. For the case of head tracking cursor control in speech driven applications, controller 9100 accesses cursor control/pointer function module 9036, which can be located locally to each HMD 100 or located remotely at a host 200 (FIG. 1A). Cursor control/function software module 9036 contains instructions to display to a user an image of a pertinent message box or the like (examples are detailed below in FIGS. 4A-4D).

The graphics converter module 9040 converts the image instructions received from the cursor control module 9036 via bus 9103 and converts the instructions into graphics to display on the monocular display 9010. At the same time text-to-speech module 9035b converts instructions received from cursor control/function software module 9036 to create sounds representing the contents for the image to be displayed. The instructions are converted into digital sounds representing the corresponding image contents that the text-to-speech module 9035b feeds to the digital-to-analog converter 9021b, which in turn feeds speaker 9006 to present the audio to the user.

Cursor control/function software module 9036 can be stored locally at memory 9120 or remotely at a host 200 (FIG. 1A). The user can speak/utter the command selection from the image and the user's speech 9090 is received at microphone 9020. The received speech is then converted from an analog signal into a digital signal at analog-to-digital converter 9021a.

Once the speech is converted from an analog to a digital signal speech recognition module 9035a processes the speech into recognize speech. The recognized speech is compared against known speech and the cursor control/pointer function module according to the instructions 9036.

The HMD 100 includes head-tracking capability. Head-tracking data may be captured from an accelerometer, although other sources of head tracking data may alternatively be used.

With head-tracking enabled, a pointer is displayed on screen 1010, 9010 when this function is activated (for example by voice command and module 9036). This pointer responds to head-tracking If the user moves his head to the left, the pointer moves to the left on screen, and vice-versa.

When the user moves the pointer so that it hovers over a displayed object or command, module 9036 (or instructions in memory 9120) displays to the user that a “grab” action is available. At this stage, the user can issue a voice command (for example, “grab object”) through microphone 9020 and the circuit comprising module 9036, and the cursor control software 9036 responsively anchors the object to the pointer. In turn this anchoring renders the object moveable in accordance with the head-tracking movements.

The user can then position the object in a new place, and can issue another voice command (for example “place object”), and the cursor control software 9036 fixes the object in the new location.

The full process is shown with the example embodiment depicted in FIGS. 4A-4D. The figures illustrate a user interface 411 that employs two moveable objects, in this example grey blocks 451, 461. The screen view (of display 1010, 9010) also displays some type of cursor/pointer 500, in this example a plus sign (+).

FIG. 4A shows the cursor 500 in the middle of the screen view (display monitor 1010, 9010) but not over any moveable objects. In the illustrated example, FIG. 4A initially shows the subject cursor 500 as a neutral pointer.

FIG. 4B shows the same cursor 500, but now superimposed or hovering over an object 461 that can be ‘grabbed’. Module 9036 or memory 9120 instructions may change color of the cursor 500, for example, to indicate to the user that an action (i.e., grabbing) can be carried out on the object 461. Other visual or audible keys may be used to indicate this and other modes of the cursor.

The user can issue a voice command to grab the object 461. Thus in FIG. 4B the cursor 500 is said to be in a ‘grab available’ mode. The user may alternatively perform a gesture with the user's head, hand or arm to direct a grab of the object 461.

FIG. 4C shows an object 461 that has been ‘grabbed’. Module 9036 or memory program 9120 has again changed visual (display) characteristics of cursor 500 (now showing a square surrounding the perimeter of the cursor) to indicate to the user that the object 461 is grabbed. Other visual or audible keys may alternatively be used to indicate that the object 461 is grabbed. The user of HMD 100 moving his head will now operate to move the object 461 along with the cursor on screen 1010, 9010. This illustrates the “object grabbed” mode of cursor operation.

FIG. 4D shows the object 461 has been moved in the screen view by the user (using head movements and thus head tracking techniques of HMD 100) to a new position or screen location of display 1010, 9010. The user can issue another voice command to stop further movement of the object 461, and in turn fix the object 461 in its current screen location/position (where the object laid when the voice command was issued). This subsequent voice command essentially disengages the cursor from the object 461, so that the cursor can once again move freely with respect to the user's head movements, independent of the object that was just moved.

The described embodiments provide the HMD user with an easy way to grab and reposition objects on-screen, hands-free, using voice commands together with head tracking

It will be apparent that one or more embodiments described herein may be implemented in many different forms of software and hardware. Software code and/or specialized hardware used to implement embodiments described herein is not limiting of the embodiments of the invention described herein. Thus, the operation and behavior of embodiments are described without reference to specific software code and/or specialized hardware—it being understood that one would be able to design software and/or hardware to implement the embodiments based on the description herein.

Further, certain embodiments of the example embodiments described herein may be implemented as logic that performs one or more functions. This logic may be hardware-based, software-based, or a combination of hardware-based and software-based. Some or all of the logic may be stored on one or more tangible, non-transitory, computer-readable storage media and may include computer-executable instructions that may be executed by a controller or processor. The computer-executable instructions may include instructions that implement one or more embodiments of the invention. The tangible, non-transitory, computer-readable storage media may be volatile or non-volatile and may include, for example, flash memories, dynamic memories, removable disks, and non-removable disks.

While this invention has been particularly shown and described with references to example embodiments thereof, it will be understood by those skilled in the art that various changes in form and details may be made therein without departing from the scope of the invention encompassed by the appended claims.

What is claimed is:

1. A headset computer comprising:
a processor configured to receive voice commands and head-tracking commands as input;
a display monitor driven by the processor; and
a graphical user interface rendered by the processor in screen views on the display monitor, the graphical user interface employing a cursor having
(i) a neutral mode of operation,
(ii) a grab available mode of operation, and
(iii) an object grabbed mode of operation;
for the different modes of operation, the processor displaying the cursor with different characteristics.

2. The headset computer of claim 1, wherein the different characteristics are visual characteristics, and are one or more of color, geometric configuration, lighting/dimming, flashing and spinning.

3. The headset computer of claim 1, wherein the processor changes cursor mode of operation in response to voice commands by a user and changes cursor screen position/location in response to head tracking commands generated by head movements of the user.

4. The headset computer of claim 1, wherein the head-tracking commands include a command to activate head-tracking and a command to deactivate head-tracking.

5. The headset computer of claim 1, wherein the head-tracking commands cause the cursor to move within the screen views.

6. The headset computer of claim 5, wherein for the grabbed object mode of operation, an object and the cursor are locked together, so that the head-tracking commands cause the cursor and the object to move together within the screen views.

7. The headset computer of claim 5, wherein the grab available mode of operation is entered when the cursor overlaps a movable object.

8. The headset computer of claim 1, wherein the neutral mode of operation, the grab available mode of operation, and the object grabbed mode of operation are entered in response to commands from the user.

9. The headset computer of claim 8, wherein the commands from the user are voice commands.

10. The headset computer of claim 8, wherein the commands from the user are gestures.

11. A method of providing hands-free movement of object on a display of a headset computer having head-tracking control, comprising:
moving, with the head-tracking control, a cursor within the display until the cursor at least partially overlaps an object within the display;
in response to a first command, locking the cursor to the object;
moving, with the head-tracking control, the cursor together with the object, from a first position within the display to a second position within the display.

12. The method of claim 11, further including unlocking the cursor from the object in response to a second command.

13. The method of claim 11, wherein the first command and the second command are voice commands.

14. The method of claim 11, wherein the first command and the second command are gestures.

15. The method of claim 11, further including activating the head-tracking control prior to moving the object, and deactivating the head-tracking control after moving the object.

16. The method of claim 11, further including waiting, once the cursor at least partially overlaps the object, for a visual characteristic of the cursor to change.

17. A non-transitory computer-readable medium with computer code instruction stored thereon, the computer code instructions when executed by an a processor cause an apparatus having head-tracking control to:
move, using head-tracking control, a cursor within the display until the cursor at least partially overlaps an object within the display;
in response to a first command, lock the cursor to the object;
move, using the head-tracking control, the cursor together with the object, from a first position within the display to a second position within the display.

18. The non-transitory computer-readable medium of claim 17, wherein the computer code instructions when executed by an a processor further cause the apparatus to unlock the cursor from the object in response to a second command.

19. The non-transitory computer-readable medium of claim 17, wherein the computer code instructions when executed by an a processor further cause the apparatus to activate the head-tracking control prior to moving the object, and deactivating the head-tracking control after moving the object.

20. The non-transitory computer-readable medium of claim 17, wherein the computer code instructions when executed by an a processor further cause the apparatus to change a visual characteristic of the cursor to change once the cursor at least partially overlaps the object.
